(19) United States
(12) Patent Application Publication
(10) Pub. No.: US 2016/0349454 A1
(43) Pub. Date: Dec. 1, 2016

(54) MULTILAYER COUPLING INTERFACE

(71) Applicants: Chunshu Zhang, Ottawa (CA); Dritan Celo, Nepean (CA); Eric Bernier, Kanata (CA)

(72) Inventors: Chunshu Zhang, Ottawa (CA); Dritan Celo, Nepean (CA); Eric Bernier, Kanata (CA)

(73) Assignee: Huawei Technologies Co., Ltd., Shenzhen (CN)

(21) Appl. No.: 14/886,285

(22) Filed: Oct. 19, 2015

Related U.S. Application Data
(60) Provisional application No. 62/168,273, filed on May 29, 2015.

(51) Int. Cl. G02B 6/26; G02B 6/12

(52) U.S. Cl. CPC G02B 6/26; G02B 6/12004; G02B 2006/12061

(57) ABSTRACT

An optical coupling input/output interface including a multilayer ribbon comprising a plurality of layers with each layer having a plurality of waveguides. The I/O interface further includes a coupling interface section, wherein the plurality of layers are staggered to allow for evanescent coupling of the waveguides of each layer with a corresponding layer of waveguides in a photonic device.

### CROSS REFERENCE TO RELATED APPLICATIONS

This application claims the benefit of priority to U.S. patent application Ser. No. 62/168,273 entitled “MULTILAYER EVANESCENT COUPLING INTERFACE” filed May 29, 2015, which is hereby incorporated by reference in its entirety.

### TECHNICAL FIELD

This disclosure relates to coupling interfaces for silicon-on-insulator (SOI) devices.

### BACKGROUND

Silicon-on-insulator (SOI) technologies are used for developing optical components, including photonic integrated circuits, which can be used in optical networking and other systems.

SOI devices require Input/Output (I/O) interfaces for allowing optical signals to enter and/or exit the SOI device. Current coupling methods include low-volume telecommunication device packaging, which does not provide a sufficiently low-cost, high-volume solution. Vertical grating couplers suffer from drawbacks of a diffractive nature. Their bandwidth is small and polarization-independent operation comes at a significant cost in transmission efficiency. In order to increase density, some grating couplers connect to the SOI device from a direction outside of the plane of the SOI device, adding complications to manufacture, space design and possible heat dissipation. Further, typical I/O edge interfaces require the precise alignment of a lensed fiber which abuts a waveguide within the SOI device. This requires high precision alignment systems as the alignment is critical due to the small spot size, which adds to the cost of such systems.

Ribbons having a single layer of waveguides have been proposed, for example in T. Barwicz, et al., Assembly of Mechanically Compliant Interfaces between Optical Fibers and Nanophotonic Chips, ECTC 2014; T. Barwicz, et al., Low-Cost Interfacing of Fibers to Nanophotonic Waveguides: Design for Fabrication and Assembly Tolerances, IEEE Photonis Journal, 2014; and Y. Taira, et al., Precision Assembly of Polymer Waveguide Components for Silicon Photonic Packaging, CPMT Symposium Japan (ICSJ), 2014 IEEE, all of which are hereby incorporated by reference in their entirety. Each of these coupling interfaces has different issues related to complexity of manufacturing, difficulty of alignment and the number of waveguides supported.

There is a need for improved I/O interfaces that allow optical signals to enter and/or exit SOI components. In particular, there is a need for such I/O interfaces to have good alignment tolerance, low loss, and low crosstalk while providing high volume.

### SUMMARY

An aspect of the disclosure provides a coupling interface for Silicon-on-Insulator (SOI) platforms. In some embodiments, evanescent field coupling (hereafter referred to as evanescent coupling) is utilized to decrease alignment requirements as compared to butting connections, while multiple layers of waveguides are used to achieve a high density optical Input/Output (I/O) interface.

A first aspect of the disclosure provides an optical coupling I/O interface which includes a plurality of layers of waveguides. The I/O interface further includes a coupling interface section, which is staggered to allow for coupling of the waveguides of each layer with a corresponding layer of waveguides in an optical device. Such an optical coupling I/O interface can form part of a Silicon Photonic processor, an SOI device or an optical coupler.

Another aspect of the disclosure provides an optical coupler which includes a plurality of layers of waveguides and a coupling interface section. The coupling interface section is staggered to allow for coupling of the plurality of layers of waveguides with a corresponding layer of waveguides in a photonic device.

Another aspect of the disclosure provides an optical device having a coupling section. A first layer of the coupling section includes a plurality of waveguides disposed within the first layer for evanescent coupling. A second layer of the coupling section includes a plurality of waveguides disposed within the second layer for optical coupling. A terminal edge of the second layer is staggered in alignment from a terminal edge of the first layer. The optical device can be a photonic device, such as Silicon Photonic processor or an SOI device, or an optical coupler.

Another aspect of the disclosure provides an SOI device. Such a device includes a plurality of layers of waveguides and a coupling interface section in which the plurality of layers of waveguides are staggered at an edge of the SOI device. This staggering allows for evanescent coupling of waveguides of each layer with a corresponding layer of waveguides in an optical coupler having a corresponding number of layers of waveguides. In some embodiments the coupling interface section is etched from an edge of SOI device. The staggering of layers in the coupling interface section provides a sufficient coupling length between the waveguides of the layers of the optical coupler and the corresponding waveguides of the SOI device to allow for evanescent coupling.

Another aspect of the disclosure provides an optical coupler which includes first and second layers, each of the layers having at least one waveguide. The coupler also includes a coupling interface section in which the first and second layers are staggered to allow for coupling of at least one waveguide in each of the first and second layers to corresponding waveguides in a photonic device. In some embodiments, at least one waveguide is positioned for evanescent coupling with a corresponding waveguide of the photonic device. In some embodiments, at least one waveguide is positioned for edge coupling with at least one waveguide in a corresponding layer of the photonic device. In some embodiments the waveguides with the layers are offset from each other. In some embodiments additional layers are included, and waveguides within may utilize evanescent coupling or another form of coupling. In some embodiments the

[symbol]

Another aspect of the disclosure provides a coupling interface having staggered first and second layers of waveguides to allow for coupling with corresponding layers of waveguides in a photonic device. At least one of the waveguides in the first layer of waveguides is arranged for evanescent coupling with the corresponding waveguides in the photonic device.

In embodiments of the above aspects, at least one of the plurality of layers has waveguides near a surface of the coupling interface section to allow for evanescent coupling with waveguides of a corresponding layer of the photonic device. The plurality of layers may be a part of a compliant ribbon which has the coupling interface section at at least one end. The waveguides may be arranged in layers and disposed within the ribbon to allow for evanescent coupling with the corresponding waveguides of the photonic device. One set of waveguides can be disposed within a layer to allow for evanescent coupling and waveguides in a different subset of the plurality of layers can be disposed to allow for a different coupling with the corresponding waveguides of the photonic device. The different coupling arrangements can include grating couplers and edge couplers. The ribbon can be further configured to connect to a concentrator located at the opposite end of the ribbon from the coupling interface section. The concentrator may include an interface to transform the pitch of the input media to the pitch of the waveguides of the ribbon. Located at a distal end of the ribbon may from the coupling interface may be a second coupling interface section, similar to the above described coupling interface section for coupling to a second photonic device.

The photonic device can be a Silicon-on-Insulator (SOI) device. Each of the plurality of layers in the coupling interface section can be separated by a gap corresponding to a gap between layers in the SOI device. The waveguides in a single layer may be laterally offset from the waveguides of another layer by a sufficient distance to allow for a reduction in crosstalk between waveguides of adjacent layers. The waveguides of one layer can be laterally offset from the waveguides of another layer by a distance corresponding to lateral offsets between waveguides in the SOI device. The edges of layers in the coupling section can be staggered to provide a sufficient coupling length between the waveguides of the layers of the ribbon and the corresponding wavelengths of the SOI device to allow for evanescent coupling. The ribbon can be composed of a polymer based material or a silicon based material. The coupling section of both the ribbon and the SOI device may have self-alignment assemblies to allow for mating of the ribbon to the SOI device. The self-alignment assembly may be a set of ribs to be inserted into a corresponding set of grooves.

The foregoing and other objects, features, aspects and advantages of the present invention will become more apparent from the following detailed description, taken in conjunction with the accompanying drawings which description is by way of example only.

### BRIEF DESCRIPTION OF DRAWINGS

For a more complete understanding of this disclosure, reference is now made to the following brief description, taken in connection with the accompanying drawings and detailed description, wherein like reference numerals represent like parts.

FIG. 1 is a perspective view of a ribbon connected to a photonic device in according with an embodiment.

FIG. 2 is a top view of the embodiment of FIG. 1.

FIG. 3 is a side cross-sectional view along line 3-3 of the embodiment shown in FIG. 2.

FIG. 4A is a side cross-sectional view along line 4A-4A of the embodiment of FIG. 3.

FIG. 4B is a side cross-sectional view along line 4B-4B of the embodiment of FIG. 3.

FIG. 4C is a side cross-sectional view along line 4C-4C of the embodiment of FIG. 3.

FIG. 5 is a side cross-sectional view of a hybrid coupling according to an embodiment.

FIG. 6 is a side cross-sectional view of an embodiment illustrating a multilayer ribbon coupling device coupling two SOI devices together.

### DESCRIPTION OF EMBODIMENTS

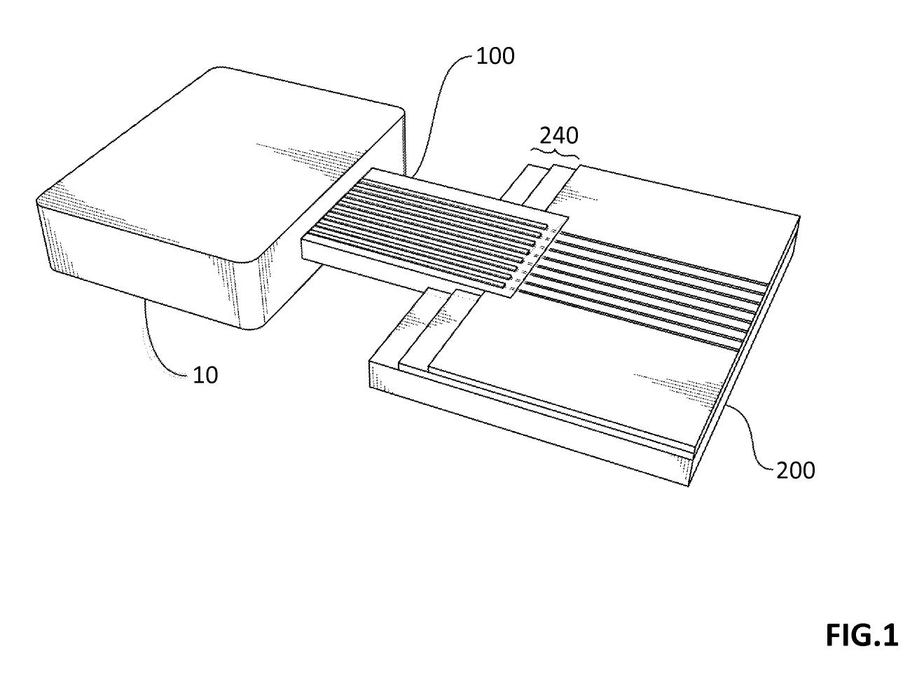

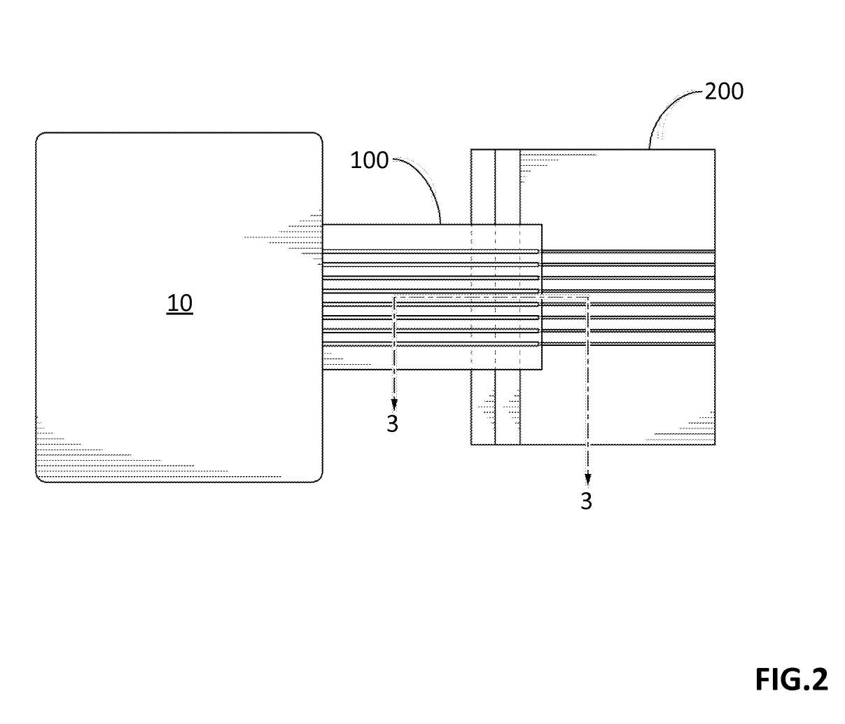

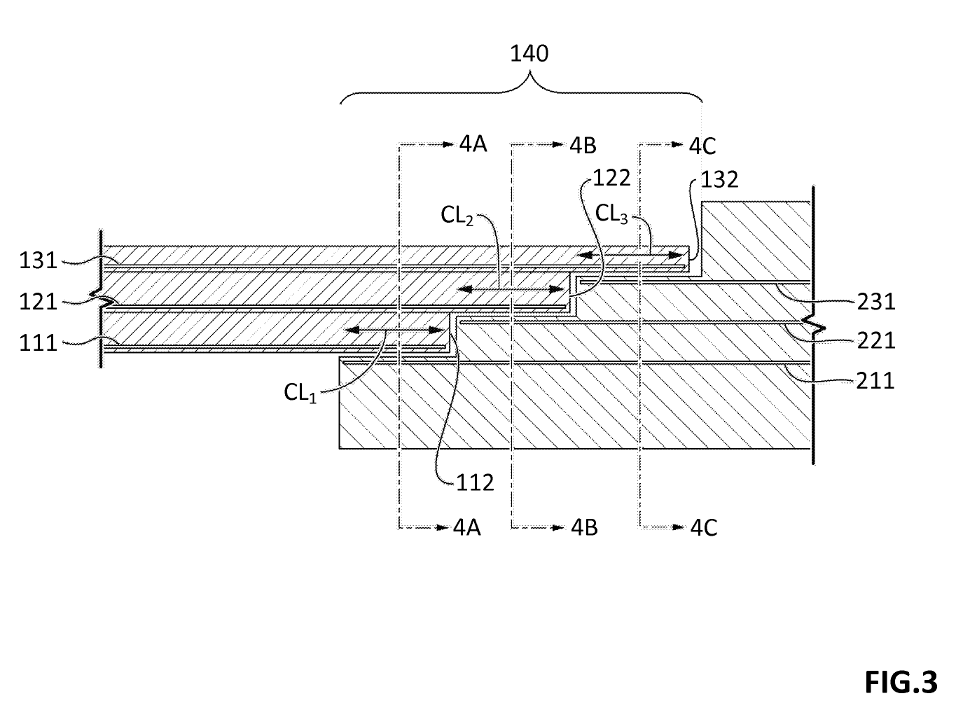

FIG. 1 is a perspective view of an embodiment of an optical coupler connected to a photonics device, FIG. 2 is a corresponding top view, and FIG. 3 is a side cross sectional view along line 3-3 of FIG. 2. The embodiment of FIG. 1 is an example of an optical coupler in the form of a compliant ribbon 100 which includes semiconductor waveguides. As shown in FIGS. 1 and 2, the ribbon 100 optically couples optical signals from a Pitch and Mode Field Diameter (MFD) concentrator 10 to a photonics device (which can be an SOI device, for example a Silicon Photonics (SiP) Die) 200. The Pitch and MFD concentrator 10 concentrates input from a plurality of fibers or a laser array, fiber or waveguide array, or other optical components such as Mux/DeMux or crossconnect (not shown). Concentrator 10 transforms the pitch from input media (e.g., single mode fiber) to the pitch of the waveguides of the ribbon 100. Accordingly, it should be appreciated that the figures are not necessarily to scale. As but one non-limiting example, such a Pitch and MFD concentrator could be made similar to the Fiber Spacing Concentrator sold by TEEM Photonics, although extended for a multilayer ribbon. Ribbon 100 connects to die 200 on a tiered interface edge 240. The edge 240 is created so that a plurality of different connection surfaces is provided through the use of a stepped edge. One skilled in the art will appreciate that waveguides are disposed within the ribbon 100 and the die 200. The waveguides within the ribbon 100 and die 200 may be arranged in a series of layers throughout, or can be separated into layers in the sections intended for coupling.

As can be seen in the embodiment of FIG. 3, SiP Die 200 includes 3 layers of optical waveguides 211, 221 and 231. The waveguide ribbon 100 includes 3 corresponding layers of waveguides 111, 121 and 131. One skilled in the art will appreciate that different embodiments may have different numbers of layers. As the ribbon 100 includes multiple layers of waveguides, it can be referred to as a 2-Dimensional (2D) ribbon. However, a different number of layers could be used, depending on the application requirements. In some embodiments, the ribbon is mechanically compliant (i.e. flexible) to facilitate alignment with the SOI device. The ribbon 100 may be formed from a polymer or silicon material. The layers 111, 121 and 131 of the ribbon 100 align with the layers 211, 221 and 231 of the SiP Die 200. In the embodiment illustrated, the ribbon waveguides are aligned above the SiP Die waveguides, as can be seen in more detail in the cross-sectional view of FIG. 3. It should be noted that the SiP Die may have other layers which are not shown.

The ribbon 100 has a coupling interface section 140 in which the edges of the ribbon are staggered to allow the waveguides of the multilayer ribbon to correspondingly overlap the silicon or silicon nitride waveguides of the SiP Die 200 when attached. The edges are said to be staggered as their terminal ends are offset from each other, with edge 132 extending beyond edge 122 by coupling length CL3. Edge 122 further extends beyond edge 112 by coupling length CL2. The waveguides in the ribbon 100 are aligned to overlap with the waveguides in die 200 to allow for evanescent field coupling, which realizes good alignment tolerance and low-loss coupling between waveguides of the ribbon and those of the photonic device (i.e. the SiP Die). Coupling length CL1 is the length in which the waveguides in layer 111 of the ribbon overlap the corresponding waveguides in layer 211 of the SiP Die 200. The coupling lengths (CL1, CL2, CL3) used allow for sufficient coupling efficiency for the desired application. The coupling lengths depend on the waveguide material, dimensions, light wavelength and gap.

It should be noted that although illustrated as being separated into layers, ribbon 100 may be monolithic in construction so that no layers are discernible. In a monolithic construction, ribbon 100 may have all lightpaths in a single layer, or there could be a variety of stacking arrangements. The lightpaths (also referred to as waveguides) then separate in advance of the edge of the coupling region so that each of the waveguides is in the correct position for coupling into the die 200.

Further, in some embodiments the entire SiP Die need not be staggered at the left edge 240 as shown. Rather, the SiP Die may be continuous at the edge, in which case etchings are made to accommodate the staggered edges of the ribbon to allow for the waveguide overlapping.

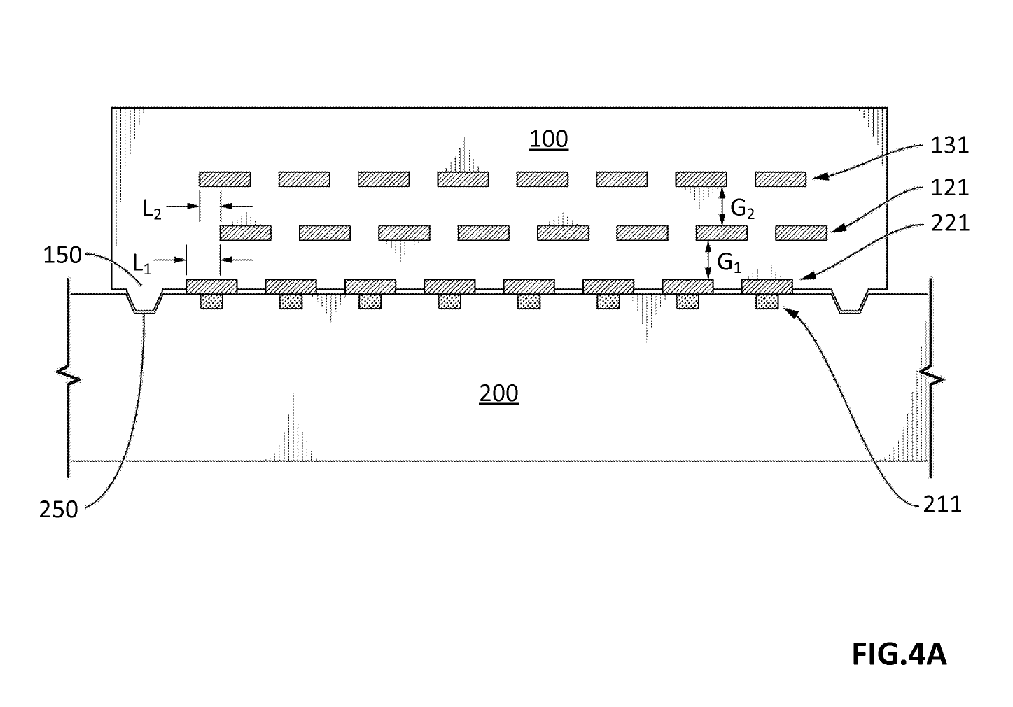

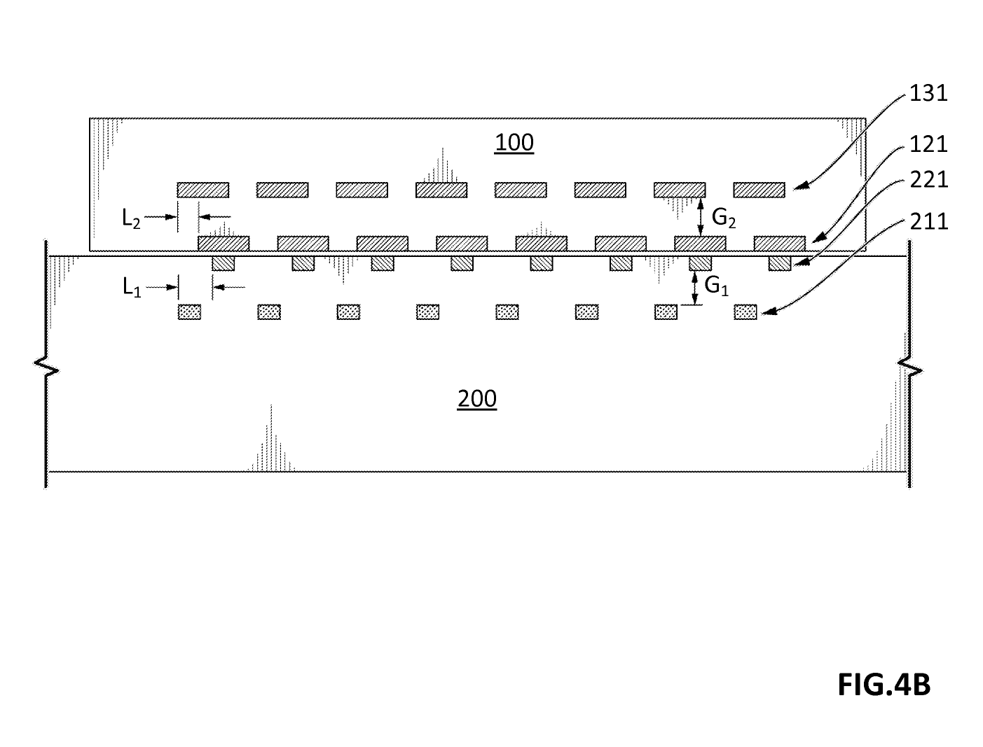

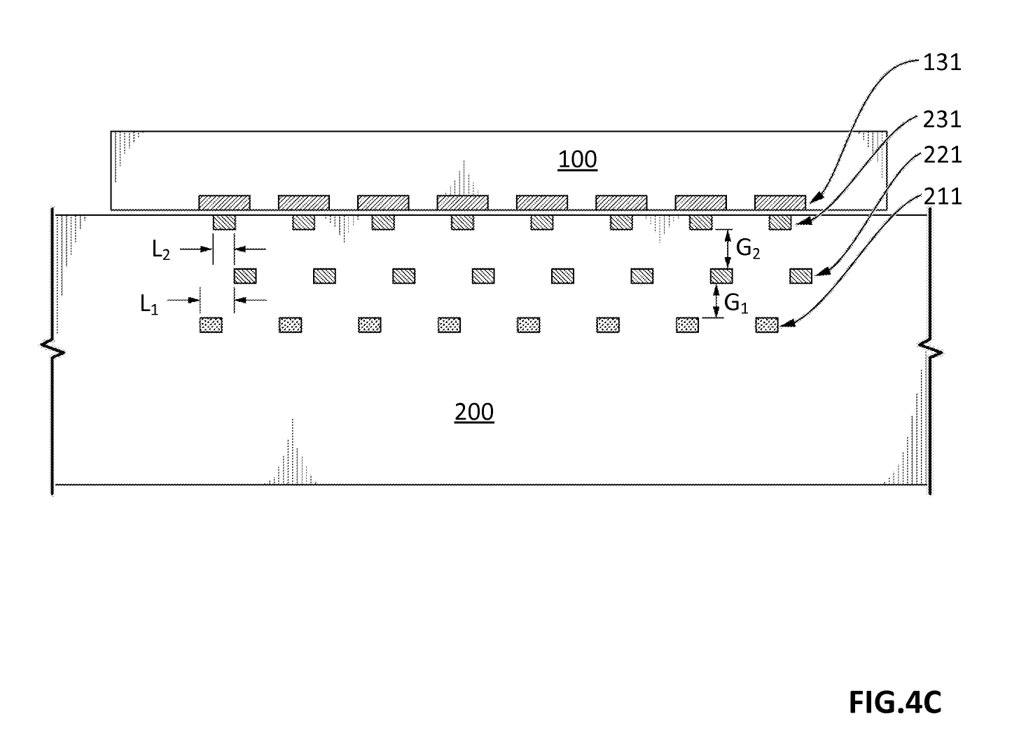

FIG. 4A is a cross-section along line 4A-4A of FIG. 3. In this section, the waveguide ribbon 100 includes 3 layers of waveguides 111, 121 and 131, with only the bottom layer 211 of the waveguides of the SiP Die 200 being visible. Eight waveguides per layer are illustrated, but other embodiments can utilize a different number of waveguides per layer. As can be seen, the bottom layer of waveguides 111 of the ribbon 100 are aligned to overlap the bottom layer of waveguides 211 of the SiP Die 200 to allow for the evanescent field coupling between them. In this embodiment, the SiP Die 200 and the ribbon 100 include an alignment structure to facilitate fast and low-cost alignments between the Sip Die 200 and waveguide ribbon 100. In this example, the alignment structure comprises a ridge 150 on the ribbon 100 that is inserted into a groove 250 in the SiP Die 200. One skilled in the art that other alignment structures could be used, or the ridge and groove could be placed on the die 200 and ribbon 100 respectively. The alignment structure is only illustrated in FIG. 4A. Alternatively, such an alignment structure could be located in the region of FIGS. 4B or 4C. Alignment structures can be provided on any or all of the layers.

The layers of the ribbon 100 are separated by gaps (G1, G2) corresponding to gaps (G1, G2) between layers in the SOI device 200. The waveguides of one layer are laterally offset from waveguides of another layer by inter-layer waveguide offsets (L1, L2). The waveguides of one layer of the ribbon 100 are laterally offset from waveguides of another layer of the ribbon 100 to align with corresponding lateral offsets between waveguides of layers in the SOI device 200. The gaps (G1, G2) and inter-layer waveguide offsets (L1, L2) between the different waveguide layers can be selected to reduce crosstalk of channels and insertion loss. The size (i.e. width and thickness) of the ribbon waveguides can be a function of the size of the waveguides on the chip to achieve minimum insertion loss.

FIG. 4B is a cross-section along line 4B-4B of FIG. 3. In this section, the waveguide ribbon 100 includes two layers of waveguides 121, 131, with two layers of waveguides 211, 221 of the SiP Die 200 being visible. As can be seen, the bottom layer of waveguides 121 of the ribbon are aligned to overlap the top layer of waveguides 221 of the SiP Die (of this section) to allow for the evanescent field coupling. FIG. 4B also illustrates that both the gaps (G1, G2) and inter-layer waveguide offsets (L1, L2) between the different waveguide layers of the ribbon 100 can be chosen to match corresponding gaps and offsets in the SiP Die 200. FIG. 4B also illustrates that the SiP Die 200 can include different types of waveguides, for example silicon and silicon-nitride waveguides. In the embodiment shown, the top layer of waveguides 221 of the SiP die are illustrated with a cross-hatch fill to indicate that they are silicon nitride waveguides, whereas the waveguides in layer 211 are illustrated with a dotted fill to indicate that they are silicon waveguides.

FIG. 4C is a cross-section along line 4C-4C of FIG. 3. In this section, the waveguide ribbon 100 only includes a single layer 131 of waveguides, with all three layers of waveguides 211, 221 and 231 of the SiP Die 200 being visible. As can be seen, the layer 131 of the ribbon is aligned so that its waveguides overlap the top layer of waveguides 231 of the SiP Die 200 (of this section) to allow for evanescent field coupling. FIG. 4C also illustrates both the gaps (G1, G2) and inter-layer waveguide offsets (L1, L2) in the SiP Die 200. FIG. 4C also illustrates that the SiP Die includes two layers of silicon nitride waveguides 221, 231 above a layer of silicon waveguides 211. This arrangement is not necessary, but can facilitate the fabrication process, for example see W. Sacher et al, Multilayer Silicon Nitride-on-Silicon Integrated Photonic Platforms and Devices, Journal of Lightwave Technology, Vol. 33, No. 4, Feb. 15, 2015, which is incorporated by reference in its entirety. If the silicon nitride waveguides have different sizes than the silicon waveguides, the sizes of the corresponding waveguides in the ribbon can be varied appropriately to achieve sufficient coupling. The silicon or silicon nitride waveguides in the SiP Die 200, or the corresponding waveguides in the ribbon 100 can be single mode waveguides or multimode waveguides, depending on the requirements for the device. The material of the waveguides in the ribbon 100 can be chosen to match the optical properties of those of the corresponding layer of the SiP Die 200. However, this may not be necessary for sufficient coupling in all implementations, and given possible increased fabrication costs of constructing a ribbon with different waveguide materials, will not be necessary for many applications. Further, while each layer is illustrated to include 8 waveguides, this is by way of example only and different number of waveguides can be used and there is no requirement that each layer of the ribbon 100 or SiP Die 200 have the same number of waveguides.

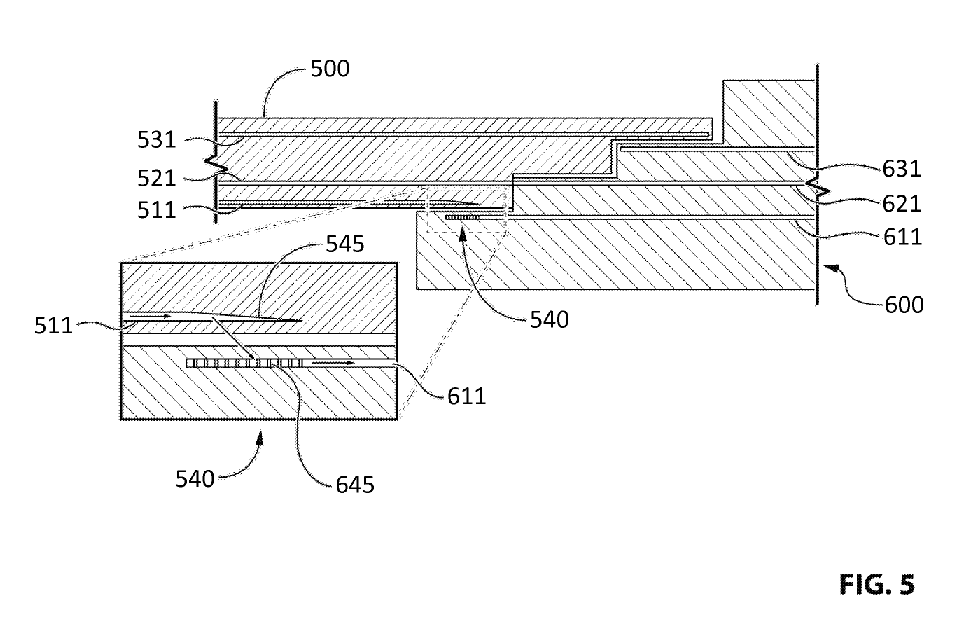

FIG. 5 is a side cross-sectional view of an alternative embodiment showing a hybrid coupling interface. Ribbon 500 has three layers of waveguides 511, 521 and 531 for coupling with corresponding layers of waveguides 611, 621 and 631 of photonic device 600. The top coupling layer utilizes evanescent coupling between the ribbon waveguides 531 and device waveguides 631 and functions as described above. The middle coupling layer utilizes edge coupling between the ribbon waveguides 521 and device waveguides 621. Those skilled in the art will appreciate that an edge coupling requires relatively tight alignment, but if the alignment requirements of this layer are satisfied the alignment of the top coupling layer will also be satisfied. The bottom coupling layer utilizes grating coupling 540. As can be seen in with the enlarged region 540 at the lower left part of the figure, the edge of ribbon waveguide 511 has a taper 545 to allow for coupling with grating coupler 645 of the lower layer of waveguide 611 of device 600. An alternative embodiment allows for hybrid coupling techniques within the same layer of waveguides. For example, a single layer of waveguides can have a first subset of waveguides using evanescent coupling, a second subset of waveguides using grating coupling and a third subset of waveguides using edge coupling. It should be noted that although three different coupling layers are shown, each with a different coupling method, it is possible for more than one layer to have the same coupling method, and only one of the coupling layers to be different than the others.

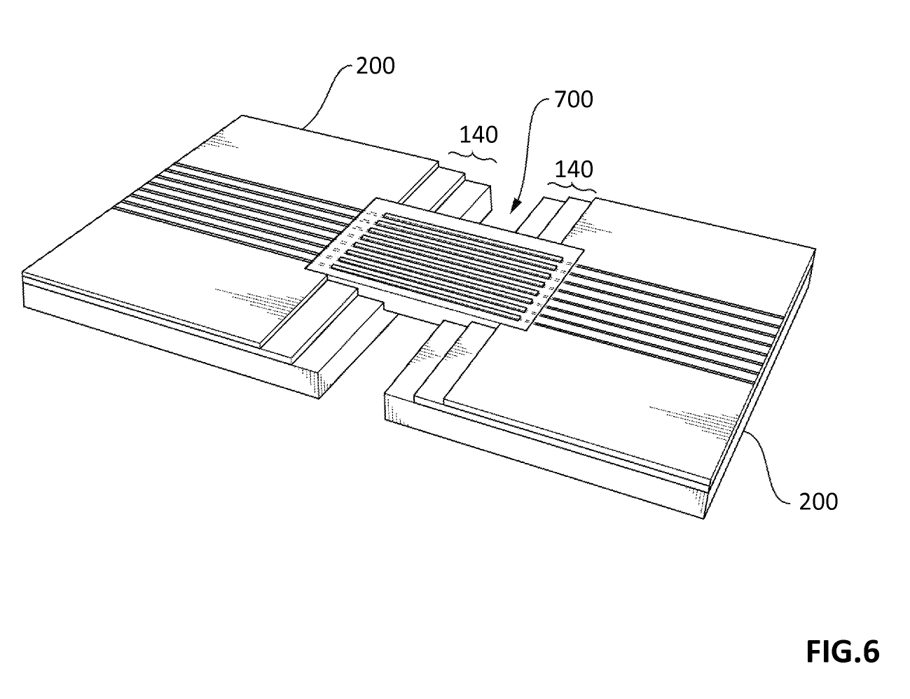

It is noted that the Pitch and MFD concentrator 10 illustrated in FIG. 1 is not necessary for the use of the optical coupler described above. As shown in FIG. 6, it is possible to use a multilayer ribbon to interconnect SOI devices. In the embodiment of FIG. 6, a ribbon 700 can interconnect two photonic devices 200. Accordingly, the ribbon 700 could be similar to ribbon 100 but would have a coupling interface section 140 at both ends.

In some embodiments, the ribbon or the SiP Die are fabricated (deposited) layer by layer. For example, a bottom layer is fabricated first, and then the upper layers are sequentially deposited overtop. Accordingly, in some embodiments the ribbon and the photonics device can be considered to include layers. Possible ways to form multilayer waveguide ribbons have been discussed in S. Garner et al, Three-Dimensional Integrated Optics Using Polymers, IEEE Journal of Quantum Electronics, Vol. 35, No. 8, August 1999; J Ryu et. al., Simple Fabrication of Double-layer Multi-channel Optical Waveguide Using Passive Alignment, Vol 19, No. 2, Optics Express 1183, January 2011; T. Korhonen et. al., Multilayer Single-mode Polymeric Waveguides by Imprint Patterning for Optical Interconnects, SPIE Proceedings Vol. 8991, Optical Interconnects XIV, March 2014; and K. Chen et al., Realization of Polymer-Based Polarization-Insensitive Interleaver Using Multilayer Waveguide Structure, IEEE Photonics Technology Letters, Vol. 23, No. 16, Aug. 15, 2011, all of which are hereby incorporated by reference in their entirety.

Accordingly, embodiments provide a multilayer ribbon interface which acts as a high density optical I/O for an SOI device that includes integrated multilayer silicon and silicon nitride waveguides. Such a multilayer waveguide ribbon can include multiple layers of silicon/silicon nitride waveguides as the optical I/O for silicon dies. The multilayer waveguide ribbon can comprise polymer or silicon based material. The multilayer ribbon can include a vertical and horizontal waveguide layout to minimize loss and crosstalk. Further, such a multilayer ribbon can provide a tolerant and compliant interface due to the evanescent coupling between waveguides, with a passive self-alignment assembly for coupling with SOI devices.

Throughout the above description, the terms optical and photonic have been used in a manner that will be understood by those skilled in the art to be generally interchangeable. A SiP Die, is typically referred to as a photonic device, while a ribbon is referred to as an optical device. These terms can be interchanged without introducing error, and the consistent use in this manner should not be considered to be limiting.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. An optical coupler comprising:
a plurality of layers of waveguides; and
a coupling interface section which is staggered to allow for coupling of the plurality of layers of waveguides with a corresponding layer of waveguides in a photonic device.

2. The optical coupler as claimed in claim 1 wherein at least one layer of the plurality of layers has waveguides near a surface of the coupling interface section to allow for evanescent coupling with waveguides of a corresponding layer of the photonic device.

3. The optical coupler as claimed in claim 2 further comprising a compliant ribbon which includes the plurality of layers of waveguides and ends in the coupling interface section.

4. The optical coupler as claimed in claim 3 wherein waveguides in each layer of the plurality of layers are disposed in the layer to allow for evanescent coupling with the corresponding waveguides of the photonic device.

5. The optical coupler as claimed in claim 3 wherein waveguides in a subset of the plurality of layers are disposed within their corresponding layers to allow for evanescent coupling and waveguides in a different subset of the plurality of layers are disposed to allow for a different coupling with the corresponding waveguides of the photonic device.

6. The optical coupler as claimed in claim 5 wherein the different coupling includes one of grating couplers and edge couplers.

7. The optical coupler as claimed in claim 3 further configured to connect to a concentrator located at the opposite end of the ribbon from the coupling interface section for coupling the plurality of waveguides with input signals.

8. The optical coupler as claimed in claim 7 wherein the concentrator includes an interface to transform the pitch of the input media to the pitch of the waveguides of the ribbon.

9. The optical coupler as claimed in claim 3 further comprising, located at the opposite end of the ribbon from the coupling interface section, a second coupling interface section for coupling to a second photonic device.

10. The optical coupler as claimed in claim 3 wherein the photonic device is a Silicon-on-Insulator (SOI) device.

11. The optical coupler as claimed in claim 10 wherein each of the plurality of layers is separated by a gap corresponding to a gap between layers in the SOI device.

12. The optical coupler as claimed in claim 11 wherein the waveguides of one layer are laterally offset from the waveguides of another layer to reduce crosstalk.

13. The optical coupler as claimed in claim 12 wherein the waveguides of one layer are laterally offset from the waveguides of another layer by a distance corresponding to lateral offsets between waveguides in the SOI device.

14. The optical coupler as claimed in claim 13 wherein edges of the layers in the coupling interface section are sufficiently staggered to provide a sufficient coupling length between the waveguides of the layers of the ribbon and the corresponding waveguides of the SOI device to allow for evanescent coupling.

15. The optical coupler as claimed in claim 14 wherein the ribbon is composed of one of a polymer based material and a silicon based material.

16. The optical coupler as claimed in claim 13 further comprising a self-alignment assembly for connecting the ribbon to the SOI device.

17. The optical coupler as claimed in claim 16 wherein the self-alignment assembly comprises a set of ribs to be inserted into a corresponding set of grooves of the SOI device.

18. A Silicon-on-Insulator (SOI) device comprising:
a plurality of layers of waveguides; and
a coupling interface section in which the plurality of layers of waveguides are staggered at an edge of the SOI device to allow for evanescent coupling of waveguides of one of the plurality of layers with waveguides in a corresponding layer of waveguides in a coupling ribbon.

19. The SOI device as claimed in claim 18 wherein the coupling interface section is etched from an edge of SOI device, where the staggering edges are sufficiently offset to provide a sufficient coupling length to allow for evanescent coupling.

20. An optical device comprising:
first and second layers, each of the layers having at least one waveguide; and
coupling interface section in which the first and second layers are staggered to allow for coupling of at least one waveguide in each of the first and second layers to corresponding waveguides in an optical device.

21. The optical device as claimed in claim 20 wherein at least one waveguide is positioned for evanescent coupling with a corresponding waveguide of the optical device.
